(19) United States
(12) Patent Application Publication
(10) Pub. No.: US 2005/0028332 A1
(43) Pub. Date: Feb. 10, 2005

(54) Fastening system

(76) Inventors: Reimar Saltenberger, Newark, DE (US); Siegfried Lautner, Newark, DE (US); Stefan Schneider, Newark, DE (US)

Correspondence Address: MILES & STOCKBRIDGE PC, 1751 PINNACLE DRIVE, SUITE 500, MCLEAN, VA, 22102-3833, US

(21) Appl. No.: 10/495,142

(22) PCT Filed: Nov. 11, 2002
(86) PCT No.: PCT/EP02/12575

(30) Foreign Application Priority Data
Nov. 13, 2001 (DE) 10156402.3

(51) Int. Cl. F16B 21/00

(52) U.S. Cl. 24/704.1

(57) ABSTRACT

A fastening arrangement (10) is proposed, with a fastening part (12) to be secured to an object (16), the fastening part being made of plastic and containing at least two through holes (50), into each of which a blind rivet member (14) is inserted, the blind rivet members (14) being insertable in location holes in the object (16) which are at a predetermined spacing (58) from each other.

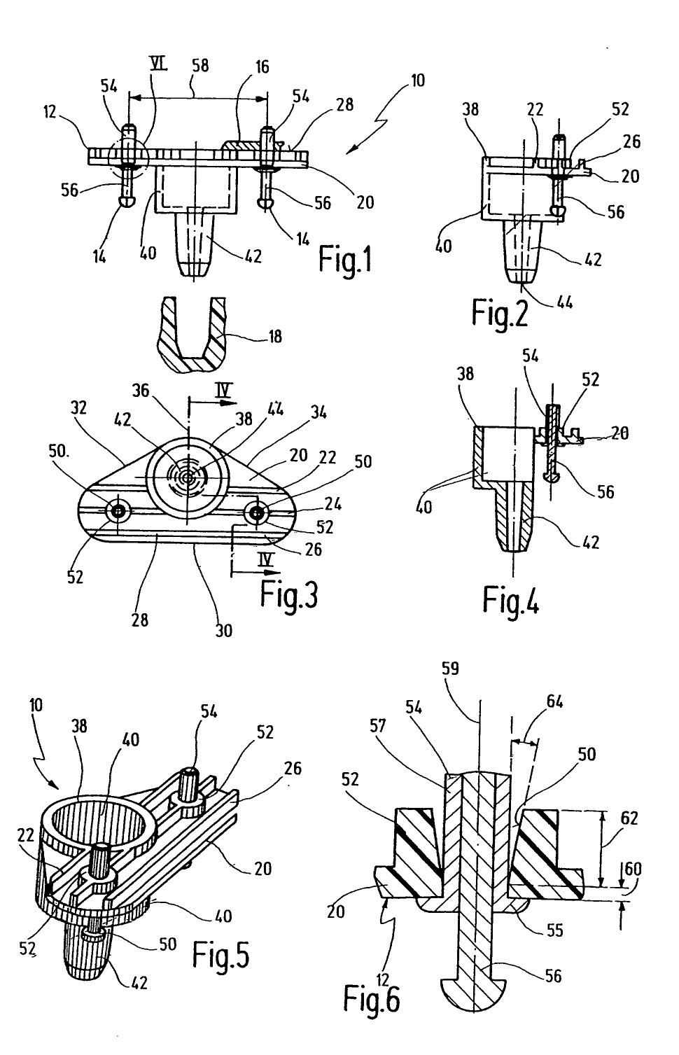

The through holes (50) each have a retaining portion (60) and an adjoining, widening-out portion (62) which are constructed so that the blind rivet members (14) are pre-mounted captive on the fastening part (12) and mounted so that they can swivel, for adaptation to the spacing (58) of the location holes in the object (16) (FIG. 1).

The invention relates to a fastening arrangement with a fastening part to be secured to an object, the fastening part being made of plastic and containing at least two through holes, into each of which a blind rivet member is inserted, the blind rivet members being insertable in location holes in the object which are at a predetermined spacing from each other.

In a known fastening arrangement of this type the two through holes are in elongated form. The fastening part is secured to the object by holding it against the object, inserting the blind rivet members through the through holes into the location holes of the object then setting the rivets.

The elongated holes are arranged so that tolerances in respect of the predetermined spacing of the location holes can be compensated.

As the fastening part is made of plastic, preferably in a low-cost injection moulding process, the through holes cannot be made circular. The tolerance for the spacing of the location holes is added to that for the position or spacing of the through holes, so assembly would not be possible in many cases.

However the elongated shape of the through holes reduces the stability of the fastening part in the region of the through holes. When the blind rivets are set the fastening part may therefore break in that region.

Moreover the securing of the fastening part to the object is expensive owing to the many individual steps.

The problem underlying the invention is consequently to provide a fastening arrangement which reduces expenditure on securing the fastening part to the object while altogether reducing the risk of the fastening part breaking.

In the above-mentioned fastening arrangement the problem is solved, in that the through holes each have a retaining portion and an adjoining, widening-out portion which are constructed so that the blind rivet members are pre-mounted captive on the fastening part and mounted so that they can swivel, for adaptation to the spacing of the location holes.

This measure firstly enables the fastening arrangement to be pre-mounted in such a way that the blind rivet members are held captive on the fastening part. This pre-mounting may optionally be made automatic. The total expenditure on mounting is considerably reduced.

Expenditure on storage, transportation etc is also lowered, as the fastening arrangement can be handled as a single mounting part.

It is particularly preferable now for the retaining portion to be shaped so that each of the blind rivet members is held captive on the fastening part by a press fit. The blind rivet members may alternatively be injected into the fastening part so they are held captive on the retaining portion.

By providing the widening-out section it is possible to swivel the blind rivet members. When the fastening arrangement is mounted the two blind rivet members can therefore be swivelled so that they can be inserted reliably in the location holes regardless of the particular dimension situation.

As a result the region around the through holes can be made altogether more stable, so that the whole breaking risk can be reduced.

It is particularly advantageous for the through holes to be circular.

The region of the fastening part around the through holes is then stronger. Even when peak forces are applied during the setting of the blind rivets damage to the fastening part is thus almost impossible.

In this context a “circular hole” is either a hole of circular cross-section or a hole of slightly elliptical cross-section. “Slightly elliptical” means for example that the main axis of the ellipse is no more than twice as long as the secondary axis.

Adequate strength can be obtained in the region of the through holes even with a slightly elliptical shape.

It is further advantageous for the tolerance-compensating portion to widen out conically from an axis of the respective through hole, particularly at an angle within the range from 2° to 15°.

An angle within this range is found to be sufficient to make the necessary compensation for tolerances, even if elongated holes are not provided.

An angle within the range from 5° to 12° is particularly preferred.

In another preferred embodiment the fastening part has a base plate onto which circular webs are moulded in the region of the through holes.

In this way the fastening part can be made stable in the region of the through holes, particularly relative to large axial loads during the setting of the blind rivets.

It is particularly advantageous for the circular webs to be moulded onto the side of the base plate facing towards the object.

This measure makes it possible to create a spacing from the base plate and the object, and yet to obtain high load-carrying capacity in respect of axial forces in the region of the through holes.

It is altogether advantageous for the internal peripheries of the circular webs each to form at least part of the tolerance-compensating portions.

The tolerance-compensating portions may either be located exclusively in the region of the circular webs or may extend into the portion of the through holes formed by the base plate.

It is further altogether advantageous for the fastening part to have a base plate, and for a plurality of ribs to be moulded onto the side of the base plate facing towards the object, to create a spacing between the base plate and the object.

Good rear ventilation of the fastening region between the base plate and the object can be obtained in this way.

It is further advantageous for a pin portion to be moulded onto the fastening part and to be insertable in a flexible bearing member in order to mount the object flexibly.

Although reference was made above to a fastening part with two through holes it will be appreciated that the fastening part may have more than two through holes, each provided with a retaining portion and a widening-out portion. It will also be appreciated that not all the through holes need have a widening-out portion to compensate for tolerances. It is conceivable, for example, for only one of two through holes to have such a portion and for the other to be held in a conventional through hole with a circular-cylindrical internal periphery.

Where the term “moulded on” has been chosen above it means that the respective moulded-on members may be moulded on in a separate step after the production of the fastening part.

However it is preferable for the fastening part to be made in one piece in one operation, preferably in one injection moulding step.

The above-mentioned features and those still to be explained below may clearly be used not only in the respective stated combination but also in other combinations or alone, without going beyond the scope of the invention.

Examples of the invention are illustrated in the accompanying drawings and will be explained in greater detail in the following description. In the drawings:

FIG. 1 is a view of an embodiment of a fastening arrangement according to the invention from the front;

FIG. 2 is a view of the FIG. 1 fastening arrangement from the side;

FIG. 3 is a plan view of the fastening arrangement in FIGS. 1 and 2;

FIG. 4 is a section taken along the line IV-IV in FIG. 3;

FIG. 5 is a perspective view of the fastening arrangement in FIGS. 1 to 4; and

FIG. 6 is fragmentary view VI from FIG. 1, in section.

In FIGS. 1 to 6 a fastening arrangement according to the invention is shown generally at 10.

In the embodiment illustrated the fastening arrangement 10 comprises a plastic fastening part 12 made in one piece, and two blind rivet members 14.

The function of the arrangement 10 is to mount an object 16 such as the radiator of a vehicle flexibly on a bearing member 18. The member 18 is made of an elastic plastic material. In cases where the object 16 is a radiator the bearing member 18 is secured to the body of the vehicle.

Both the object 16 and the bearing member 18 are shown only diagrammatically. It will be appreciated however that in the object 16 suitable, unspecified location holes are provided, into which the blind rivet members 14 may be inserted, so that the rivet members can then be set by means of a suitable tool. The fastening part 12 is thereby secured to the object 16.

The fastening part 12 has a base plate 20, which in plan view is approximately shaped as an obtuse-angled triangle with rounded angles.

A plurality of parallel ribs 22, 24 are provided on one side of the base plate 20, the tops of the ribs defining a common contact surface 28.

The ribs 22, 24, 26 are approximately parallel with a base 30 of the triangular base plate 20. The sides of the triangular shape extending from the base 30 are designated 32 and 34.

The apex of the triangular shape is shown at 36.

A circular web 38 is formed on the ribbed side of the base plate 20 in the region of the apex 36. It ends at the same level as the ribs 22, 24, 26, that is to say, it also defines the supporting surface 28.

The web extends to the edge of the base plate 20, so that a section of its outer periphery is flush with the apex 36 of the base plate.

A cylindrical hollow bush portion 40 of the same cross-section as the circular web 38 is formed at the opposite side of the base plate 20. The hollow bush portion 40 is adjoined by a slightly tapering pin portion 42 which is hollow. There is consequently an opening 44 at the front end of the slightly tapering pin portion 42.

The conical pin portion 42 is designed for insertion in a matching conical recess in the bearing member 18 in order to mount the object 16 flexibly.

As the pin portion 42 is approximately perpendicular to the base plate 20, the flexible bearing is designed to absorb transverse forces parallel with the plane of the base plate 20. The flexible bearing can optionally also absorb axial shocks in the longitudinal direction of the pin portion 42.

Two circular holes 50 are also formed in the fastening part 12. They are positioned so that they and the opening 44 are arranged in a triangular shape corresponding to the triangular shape of the base plate 20.

Circular webs 52 are formed around the circular holes 50 on the side of the base plate 20 facing the object 16. These also extend to the contact surface 28.

The webs 52 are integral with one of the ribs, here the rib 24.

The blind rivet members 14 in known manner each have a hollow rivet 54 with a flange 55 and a cylindrical shank portion 57, and a mandrel 56 passing through the hollow rivet 54.

The members 14 are pre-mounted captive in the circular holes 50. They are inserted in the holes 50 from the side of the base plate 20 opposite the object 16. The flanges 55 of the hollow rivets 54 consequently lie on the non-ribbed side of the base plate 20.

In this context “captive” means that the blind rivet members 14 and the fastening part 12 can be treated as a unit. With forces which normally occur during storage and transportation the pre-mounting makes it substantially impossible for the blind rivet members 24 to come out of the circular holes 50. Nevertheless if a force exceeding normal forces is applied it is of course possible to remove the members 14 from the holes 50.

The fastening arrangement 10 can be mounted on the object 16 by inserting the cylindrical shank portions 57 projecting from the ribbed side of the base plate 20 in corresponding location holes in the object 16.

The location holes in the object 16 are at a predetermined distance from each other, shown at 58 in FIG. 1.

The distance 58 between them may vary according to the permissible manufacturing tolerances. It is also possible for the distance between the circular holes 50 to vary from one fastening part 12 to another according to manufacturing tolerances.

To enable the cylindrical shank portions 57 to be inserted easily in the location holes in the object 16 in spite of any variation, the fastening part 12 is constructed as follows.

As will be seen from FIG. 6, the internal periphery of the circular holes 50 has a retaining portion 60 and a tolerance-compensating portion 62 along a longitudinal axis 59.

The retaining portion 60 extends from the non-ribbed side of the base plate 20 to approximately half the thickness thereof. It is adjoined by the tolerance-compensating portion 62. This is a portion which widens out conically towards the object 16. The cone angle in the embodiment shown is 10°.

The retaining portion 60 is dimensioned so that the cylindrical shank portion 57 is press/fitted in it. The respective blind rivet member 14 is consequently pre-mounted captive on the fastening part 12. The conical widening-out of the tolerance-compensating portion 62 enables the blind rivet member 14 to be swivelled slightly relative to the axis 59 in the pre-mounted state of the member 14. The point of rotation for the swivelling movement is approximately in the region of the top of the flange 55 owing to the contact between the flange 55 and the base plate 20.

This ability to swivel or tilt enables both cylindrical shank portions 57 to be inserted in the location holes in the object 16 without greater loads on the fastening part 12, in spite of varying spacings 58.

Owing to the fact that the whole surface of the flange 55 rests on a surface of the fastening part 12, and owing to the fact that the piece of the fastening part 12 “below it” is solid, in the form of the circular web 52, strong axial forces can be absorbed when setting the blind rivet member 14. Even if the members 14 are set in an easy, inclined position, no inadmissible tensions appear in the fastening part 12.

All in all the fastening arrangement 10 can be mounted easily and securely on the object 16. The fastening arrangement 10 can be handled and stored as one component. Furthermore the solid construction around the region of the through holes 50 largely prevents any damage to the fastening part 12 during the setting of the blind rivet members 14.

1. A fastening arrangement (10) with a fastening part (12) to be secured to an object (16), the fastening part being made of plastic and containing at least two through holes (50), into each of which a blind rivet member (14) is inserted, the blind rivet members (14) being insertable in location holes in the object (16) which are at a predetermined spacing (58) from each other,
characterised in that
the through holes (50) each have a retaining portion (60) and an adjoining, widening-out portion (62) which are constructed so that the blind rivet members (14) are pre-mounted captive on the fastening part (12) and mounted so that they can swivel, for adaptation to the spacing (58) of the location holes in the object (16).

2. The fastening arrangement according to claim 1, characterised in that the through holes (50) are circular holes (50).

3. The fastening arrangement according to claim 1, characterised in that the tolerance-compensating portion (62) widens out conically from an axis (59) of the respective through hole (50), particularly at an angle (64) within the range from 2° to 15°.

4. The fastening arrangement according to claim 1, characterised in that the fastening part (12) has a base plate (20) onto which circular webs (38) are moulded in the region of the through holes (50).

5. The fastening arrangement according to claim 4, characterised in that the circular webs (38) are moulded onto the side of the base plate (20) facing towards the object (16).

6. The fastening arrangement according to claim 4, characterised in that the internal peripheries of the circular webs (38) each form at least part of the tolerance-compensating portions (62).

7. The fastening arrangement according to claim 1, characterised in that the fastening part (12) has a base plate (20), and that a plurality of ribs (22, 24, 26) are moulded onto the side of the base plate (20) facing towards the object (16), to create a spacing between the base plate (20) and the object (16).

8. The fastening arrangement according to claim 1, characterised in that a pin portion (42) is moulded onto the fastening part (12) and can be inserted in a flexible bearing member (18) to mount the object (16) flexibly.
